(19) United States
(12) Patent Application Publication
(10) Pub. No.: US 2010/0257196 A1
(43) Pub. Date: Oct. 7, 2010

(54) SYSTEM AND METHOD FOR MANAGING WIDGETS

(75) Inventors: Keith Waters, West Newton, MA (US); Keith Rosenblatt, Belmont, MA (US)

Correspondence Address: THORNE & HALAJIAN, LLP, 111 WEST MAIN STREET, BAY SHORE, NY, 11706, US

(73) Assignee: FRANCE TELECOM, Paris (FR)

(21) Appl. No.: 12/743,228

(22) PCT Filed: Nov. 14, 2008
(86) PCT No.: PCT/IB08/55642

§ 371 Date: May 14, 2010

Related U.S. Application Data
(60) Provisional application No. 60/987,990, filed on Nov. 14, 2007.

(51) Int. Cl. G06F 17/30

(52) U.S. Cl. 707/769; 707/E17.014

(57) ABSTRACT

The invention relates to method for managing a set of widgets displayed on the graphical user interface (GUI) of a device, said method comprising the acts of receiving contextual data from the device, querying with the received contextual data a repository of widget configurations for the set of widgets, said widgets configurations being described in said repository as functions of the possible contextual data values, displaying the set of widgets using the configuration that match the received contextual data.

### FIELD OF THE PRESENT SYSTEM

The present invention generally relates to graphical user interfaces (GUI) and more specifically to the management of user interface elements known as widgets.

### BACKGROUND OF THE PRESENT SYSTEM

Today, there is an explosion of digital content available over the internet.

With this explosion comes the need to channel and filter the ever increasing content load to avoid an overflow of information, whether the content is pushed or pulled to the users' end devices, such computers, mobile equipments like cell phones, personal digital assistants (PDA) and the likes.

Users generally access the content through the graphical user interface (GUI)—or desktop—of a device and can sort the related information displayed through graphical objects, such as windows, menus, taskbars, and the likes. These objects can be customized to facilitate the user interaction with the information, but the experience can prove overwhelming as more graphical objects may overload the GUI.

Widgets have been introduced to overcome this desktop limitation. Widgets can be defined as light-weight single-purpose applications that can operate on the user's GUI. Widgets may be also seen as scaled-down applications providing only key information rather than fully functional services typically presented on the desktop. Generally, widgets may channel information to the user, and allow said user to perform a variety of tasks, including for example communicating with a remote server to provide information to the user (i.e. a widget that needs a synchronization with a data source, like e.g., weather report, list of mails, latest value for his/her stock portfolio, and the likes), providing commonly needed functionality (e.g., a calculator), or acting as an information repository (e.g., a notebook). Other examples of widgets services are headline news, dictionary, mapping, sticky notes and language translation.

While most widgets are connected to on-line web services, such as weather services, they can also operate off-line, for example a clock, a game or a local address book. Numerous widgets exist today for desktops and an ever increasing number of them are being generated by simple authoring tools for users.

To date widgets have been developed for a desktop experience, where multiple widgets can be managed. Widgets are now available in lightweight devices such as mobile equipments or devices (e.g. mobile phones), PDAs and the likes. The widgets are then called mobile widgets and correspond generally to mini-applications that deliver customized visual information to a mobile display. Example widgets services are: headline news, current weather, dictionary, mapping, sticky notes and language translation, similarly to the widgets available on desktop computers. As mobile devices may track their position (through GPS for example), location based services (LBS) may be accessible through location based widgets.

Widgets are quintessentially suited to small displays where user interactions are hard to perform. Mobile phones are suitable platforms for these mini-applications because the content presentation is condensed to only essential visual components. While mobile widgets on mobile devices are effective, the mechanisms to manage, control and interact with widgets remains problematic. This is due to impoverished interaction facilities on mobile devices. FIG. 8 illustrates the GUI 810 of a mobile device 800 with a possible active widgets layout. A plurality of widgets 820 is actively displaying thanks to a browser 815 information in small regions of the GUI 810. For example the changing weather conditions, current stock values, traffic delays, a calculator or the number of pending emails. The widgets 820 may be selected using the navigation button 830 and/or the keypad 835 to zoom in the selected widget. Such a selection could allow for a far more detailed set of information from the selected widget.

Widgets in general have limited customization, whether they are used for mobile equipment or not. They can generally be configured, i.e. modified through configuration settings, also called here after preferences. A stock tracker widget can be configured to display certain stocks. The selection of a postal code may be used to configure a weather widget to report weather from a given area or city. A user may change the widget preferences over time, for instance when he/she arrives in a different location, needs a traffic report for a specific itinerary, or when his/her stock portfolio has changed. A widget can also be deactivated if the user is no longer interested in monitoring a given piece of information. Some customization of a widget can be done while the widget is running, e.g., by directly interacting with a mouse or keyboard of a desktop or laptop computer or a keypad of a light weight device.

An example of widget management engine and method is described in Apple U.S. Ser. No. 11/499,887. In this disclosure a set of widgets can be managed on a desktop through user input of configuration information and synchronized with a data source. The widgets sets of two distinct devices may be synchronized with one another. Some widgets, e.g. a news, weather or traffic widgets, may need a periodic synchronization with a data source to update the displayed information. For example, a news widget needs an update to display the latest news, a mail box widget needs to synchronize with a mail server to give an up to date status of a user's mail box. These content updates are limited by essence because the content updates are linked to what the data source may provide. Furthermore, the update may be periodic, either controlled by the end device itself of the widget module. They may also be triggered by the data source whenever an update is available.

Another example is described in Apple U.S. Ser. No. 11/429,492. The proposed widget platform is designed to allow users to select widgets, typically from an online source and subsequently configured the selected widgets once for display. A widget engine in this context is responsible for the execution and display of the widgets. When the engine is operational, no dynamic widget control is performed. Each widget operates independently with a data source such as a web service. Only through manual intervention by the user are widgets removed from the display. This is achieved through a graphical user interface with explicit buttons and graphical objects that allow widgets to be incorporated in the final display or not. Likewise manual intervention through a graphical user interface is required for each widget to modify a widget's preferences.

Both these examples deal with content adaptations. Content adaptation for mobile handsets deals with mechanisms that determine the devices physical characteristics, in particular screen width, height and bit depth, as well other resources, to determine how to shape the content to fit the device. Mobile content adaptation can occur either on the device, or alternatively in the network prior to being accessed by the device.

To date, it is not possible to activate, or deactivate, a set of widgets displayed on a GUI based upon preferences. Furthermore, it is neither possible to adapt a widget presentation based on the contextual information of the device they are displayed on. Content adaptation is still constrained to the device physical characteristics. It would be also highly desirable if the management of the widgets could be performed without user intervention.

There is still a need today for an improved management of the set of widgets displayed on a GUI. There is a further need for managing the set of widgets with no user input.

### SUMMARY OF THE PRESENT SYSTEM AND METHOD

It is an object of the present system, processor and method to overcome disadvantages and/or make improvements in the prior art.

To that extent, the present method proposes a method for managing a set of widgets displayed on the graphical user interface (GUI) of a device, said method comprising the acts of:
receiving contextual data from the device,
querying with the received contextual data a repository of widget configurations for the set of widgets, said widgets configurations being described in said repository as functions of the possible contextual data values,
displaying the set of widgets using the configuration that match the received contextual information.

Thanks to the present method, an automatic management and control of a plurality of widgets is permitted on a device though the definition of context based selection mechanisms. This method is particularly relevant to small screen mobile devices with a plurality of widgets. The control of the widgets is achieved through the use of predefined rules—which correspond to the widget configurations—that determine individual widget behavior as functions of the device's contextual data.

The user's experience with widgets is improved through the combination of multiple widget selection and individual widget preferences on various GUIs, such as, but not limited to, small screen devices.

A processor to manage widgets displayed on the graphical user interface (GUI) of a device is also described hereafter. In one embodiment of the present processor, said processor comprising:
a portion configured to receive contextual data from the device,
a portion for querying with the received contextual data a repository of widget configurations for the set of widgets, said widgets configurations being described in said repository as functions of the possible contextual data values,
a portion configured to display the set of widgets using the configuration that match the received contextual data.

### BRIEF DESCRIPTION OF THE DRAWINGS

The present system and method are explained in further detail, and by way of example, with reference to the accompanying drawings wherein:

FIG. 1 shows an exemplary embodiment of the system according to the invention,

FIG. 2 shows a flow chart illustrating how the state of a set of widgets may shift according to an exemplary embodiment of the present method,

FIG. 3 shows a detailed flow chart illustrating how the preference module selects configuration settings for the set of widgets according to the exemplary embodiment of the present method,

FIG. 4 shows an exemplary illustration of the widgets content shift according to an additional embodiment of the present method,

FIG. 5 shows a mobile handset with a display illustrating a browser with active widget icons,

FIG. 6 shows a detail of the mobile display with a possible three by three widget icon layout, and;

FIG. 7 shows a time line illustrating the potential widgets displayed within a Weekday AM, Weekday PM cycle combined with weekend cycle.

### DETAILED DESCRIPTION OF THE PRESENT SYSTEM AND METHOD

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims.

For example, the system and method described therein allows a unique personalized experience for the user. The system will be described hereafter in its application to a widget server with which a mobile device (such as a cellular phone) interacts. The man skilled in the art will notice that this is not the sole embodiment possible, and that the system and method according to the invention may be completely implemented on a user device (or client device) such as a personal computer, a PDA, a phone, or the likes. The different modules may also be hosted by separate servers and accessible over a network.

Moreover, for the purpose of clarity, detailed descriptions of well-known devices, systems, and methods are omitted so as not to obscure the description of the present system. A widget generally refers to the application itself, while a widget icon is its representation on the GUI. For the sake of simplicity, widget will also be used to refer to the widget icon. In addition, it should be expressly understood that the drawings are included for illustrative purposes and do not represent the scope of the present system.

Unless specified otherwise, the exemplary embodiment will be described hereafter in the context of a mobile device interacting with a distant widget server.

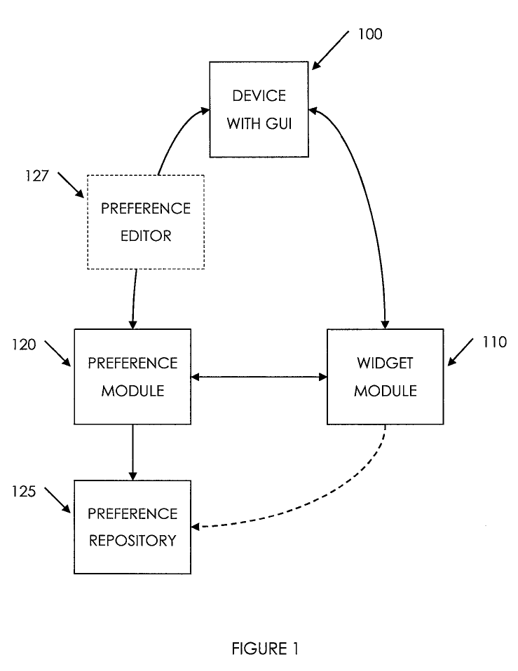

FIG. 1 shows an exemplary embodiment of the system according to the invention. A electronic device 100 comprising a user interface, like a GUI, is used by an end-user to display a set of widgets on said interface. In the exemplary illustration of FIG. 1, the device is a mobile equipment or handset. Such a light weight (i.e. with limited Central Processing Unit) mobile device may be equipped with a web browser, i.e. a software application that enables a user of the device to display and interact with text, images, videos, music and other information comprised on a webpage built by a website the device may connect to. Such a website is generally hosted by a server accessible through a network such as e.g. the World Wide Web or through a local area network (LAN).

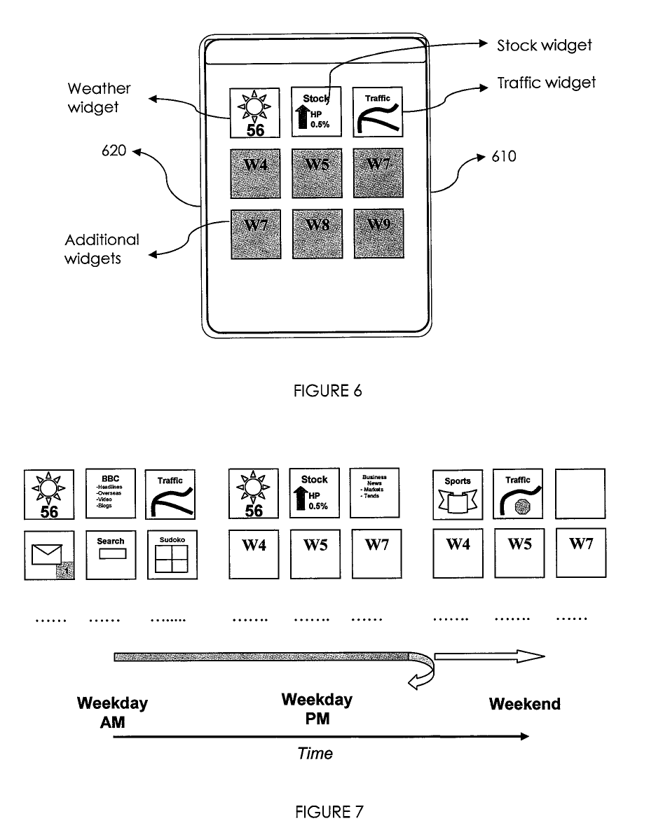

The system according to the exemplary embodiment of FIG. 1 further comprises a widget module or server 110 responsible for managing the set of widgets displayed on the GUI of the device. Widget module 110 is also responsible for providing the widget content to device 100. Widget server 110 may be seen as a web server responsible for serving the widget framework and widget update data to the device 100. Once a widget webpage, as seen for example in the illustration of FIG. 6, is built by widget server 110, it is downloaded to the mobile equipment and displayed on its GUI. As any known webpage, the widgets that will be displayed by the GUI may be comprised in the downloaded webpage, or hosted by the device itself. The various widgets implementations that exist today and that may be used by widget module 110 to display the set of widgets are beyond the scope of the present specification.

Device 100 is adapted to collect and forward to the widget module 110 contextual information about said device. By contextual information, one may understand any parameter describing or characterizing the present state of the device. This may include its location (when the device can track its position), time, temperature, . . . . This could include for example, but not limited to, the state of its memory, the type of network it is connected to, the state of its battery, . . . .

To each widget corresponds configuration settings or preferences, which allow the control and adaptation of the widget, and the information it will display. The configuration settings, depending of their values, may cause the widget to be active or not (i.e. displayed on the GUI or not), to display different types of content, . . . . In the present system, the configuration settings for each widget available to the device 100 are context-based configurations, i.e. they are defined as functions of the possible values of the device 100 contextual information or data. These settings are stored in a preference repository 125, e.g. a relational database. For example, the active or inactive state of a widget may be defined as a function of the contextual information. In other words, a widget may be rendered active or inactive based on the device contextual information. When for example the contextual information is the time, the widget may be active during this time interval of the day, and inactive during this other time. Therefore, the active/inactive state of a widget may be defined in repository 125 as a function of the time, location, or any contextual information device 100 may monitor. For a news widget, the content displayed may be configured to vary during the day, displaying general news in the morning for example, and sports news in the evening.

In the present system, widget server 110, once it has collected the contextual information from the device 100, is arranged to query repository 125 with said contextual information. Using the configuration settings that correspond to, i.e. match the received contextual data, widget server 110 may build a webpage with the widgets operating according to the updated widget settings matching the present contextual information of the device.

FIG. 7 illustrates an example of a GUI of a device 100 performing an exemplary embodiment of the method according to the invention. In this example, a series or set of widgets, have been selected by a user. These widgets are namely:
a weather widget,
a news widget, that may display headline news, sports news, or business news,
a stock market widget
a traffic widget,
a mail widget,
a search box widget,
a game widget are displayed on.

A set of widgets may be seen as the widgets of interest to the end-user. He/she may at any time update the set of widgets by removing or adding new widgets, and defining configurations settings for the added widgets. As many widgets may be of interest to a user, the present system and method allow for a display of only the most relevant widgets to the users, taking into account his/her varying interest that are expressed as functions of the device contextual information. Furthermore and conversely to what is known in the prior art, the present system allows for an update of the displayed widget content that goes beyond the simple synchronization with a data source.

The configuration settings of these widgets may be defined for example as a function of the time and the location of the mobile handset in repository 125. Thus the configuration settings of the news widget may be defined so that the news widget is configured to display general news in the morning of a weekday, business news in the afternoon of a weekday, and sports news on a weekend from the same data source. The configuration settings of the news widget allows to synchronize this widget with difference sources depending in this example on the time of the day and of the week. In the present system, the synchronization with a data source is thus based on the contextual information of the end device.

In another example, the weather widget preferences are defined so that this widget is configured to be active and synchronize the weather information for a different region depending on the day of the week. A user traveling every weekend to his/her country house may want to have his/her city weather displayed on weekdays, and his/her country house weather starting on Friday to prepare for his/her weekend. The traffic widget may be configured to display only on weekdays morning the road traffic when the user's commutes to work or when the user goes to his country home on weekends.

As the widget module 110 received the contextual information from device 100, here in this example location and time, it collects from repository 125 the configuration settings for the set of widgets here above, and configure the widgets accordingly. As seen on FIG. 7, from left to right, the widget news displays headline news on weekdays mornings, business news on weekdays evenings and sports news in the weekends. The weather widget, active on weekdays, becomes inactive on weekends.

In the exemplary illustration of FIG. 1, widget module 110 may query directly preference repository 125 with the device contextual information (dotted line in FIG. 1). Widget module 110 is then arranged both to retrieve the right preferences from repository 125 and manage and display the set of widgets using said preferences.

As illustrated in the example of FIG. 1, widget module 110 may query indirectly preference repository 125, the retrieval of the right preferences being handled by a separate module 120, or preference module (as seen in straight lines in FIG. 1). Preference module 120 may be a preference server, i.e. a web service responsible for providing to widget server 110 the configuration settings matching the device contextual information. Widget server 110 and preference server 120 may be in this example two separate servers interacting over a network.

In order to define the preferences according to the possible values of a device contextual information, a user may interact with the preference module 120, which is also responsible for providing a mechanism through which users can maintain and/or update context-based configuration setting for a selected set of widgets. A preference editor 127 may be used by a user to interact with preference module 120 and modify the configuration settings. The preference editor may be hosted by device 100 or available on the preference module 120.

Referring again to the example of FIG. 7, a user may access with his/her device 100 the preference module 120, and edit the set of widgets preferences using preference editor 127. He/she may set the weather widget to be active only on weekday mornings, or define the news widget content depending on the time of the day and the week. The preference module may also be accessed from a device other than device 100 used to display the set of widgets. A desktop computer may be for instance used to access the preference module 120 to edit and modify the widget preferences.

The illustration of FIG. 1 corresponds to web based embodiment of the present system. Other implementations are readily available to the man skilled in the art. As mentioned earlier the widget and preference modules may be part of the same module. The widget module may be a client to the device 100, while the preference module 120 is a distant server. Conversely, the preference module may be a client to the device 100 while the widget module 110 is a distant server. The maintenance and update of the configuration settings and the retrieval of the right configuration settings, two functions handled by preference module 120 in the illustration in straight lines in FIG. 1 may also be handled by separate modules. Other combinations of the various functions illustrated here above are also within the scope of the present system.

Device 100 may also be any web browser-based platform such as a desktop computer or an independent unit hosting most if not all the different modules of the present system. The access to the network may be wireless or not, device 100 being equipped with the right communication interfaces according to access the network.

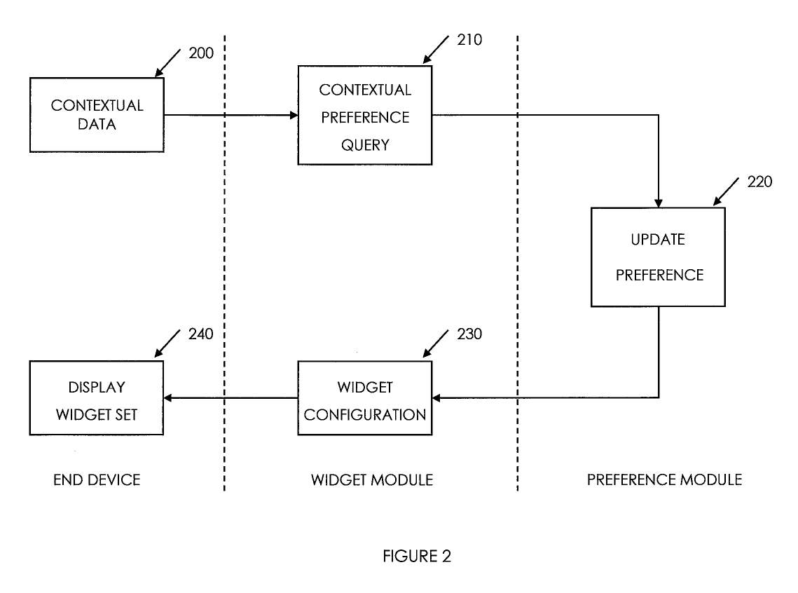

The present system and method allow for a context shifting of the widget set displayed on the device 100, i.e. a shifting based on the contextual data of the device. As seen before the shifting may be a shift between the active and inactive state of a widget, here after referred to as a state shift, or a shift in the content displayed on the GUI, here after referred to as a content shift. An embodiment of the present method is illustrated in FIG. 2 for the state or content shift. The method is illustrated with the preference module and the widget module as separate modules.

Device 100 is assumed to display a series or set of widgets as illustrated in the example of in FIG. 6. In this example only 3 widgets are active, i.e. actively displayed. The exemplary GUI 610 has 9 possible spots to display widgets W1 to W9, with 6 empty through browser 620. Selecting the widget will allow the whole widget to be displayed on the mobile display, for an enhanced and details viewing of the widget information. The end user is also assumed to have selected a set of widgets for his/her device, and define the context based configuration settings for the selected widgets through the preference editor mentioned earlier on.

In a preliminary act 200, the end device collects contextual information or data about its present state. This may include location, time, . . . as mentioned before. Act 200 may be performed on a regular basis, or whenever one of the monitored contextual parameter varies beyond a given range. The sampling of the different parameters may also vary from one parameter to the other, depending e.g. on its nature. Device 100 then forwards the contextual information to the widget module 110. The forwarded data may be limited to e.g. the parameters that triggered the sampling, the parameters the value of which varied from the previous sampling or all parameters.

In a further act 210, the widget module, in order to update the widget page, queries the preference module 120 with the received contextual information, to retrieve updated preferences for the currently displayed set of widgets.

In a further act 220 of the present method, the preference server retrieves the configuration settings for the set of widgets that apply (i.e. correspond) to the received contextual information. An update of the set of widgets preferences is thus achieved. Depending on how the information is organized in preference repository 125, preference module 120 may browse repository 125 by widget, or by contextual parameter, or any suitable entry. In other words, in act 220, preference module evaluates end device context against the context based configuration settings, which may be seen as a set of defined rules.

The identified preferences are forwarded to the widget module in a further act 230, so that the widget module may update the set of widgets accordingly, e.g. activating or deactivating a number of widgets (state shift) and/or changing the rendered information (content shift). In other words, preference module returns to the widget module a context-selected set of response data. This returned data includes the widgets themselves (i.e. the active ones), as well as the underlying information the widgets use for generating the display presented to the end-user. In the exemplary embodiment of a widget server, an updated widget page is built using the identified preferences. In a final act 240, widget module 110 sends the updated widget page for a further display on the end device.

In the here above illustration, the widget themselves, i.e. the widget code is returned. In order to limit the data transfer in this act, in an additional embodiment of the present method, the widget code will be transferred only for a widget which becomes active in the updated widget page. For already running widgets, as only the configuration may change, the data transfer may be limited to the new set of preferences, the update being performed on the client side (end device) or on the widget module.

In repository 125, the configuration settings for each widget are stored as functions of the possible values of the device contextual information.

One possible way of storing the settings as functions of the contextual data may be to first define intervals—or ranges—of values for each parameter characterizing the contextual information of the device. The different intervals are not necessarily contiguous as illustrated here after. An example implementation of various time ranges for use in time-based preferences is shown here below in Table 1:

TABLE 1
An example time range set

| NAME FOR TIME | |
|---|---|
| RANGE | VALUE |
| Sunday | 0/0000-2359 |
| Monday | 1/0000-2359 |
| Tuesday | 2/0000-2359 |
| Wednesday | 3/0000-2359 |
| Thursday | 4/0000-2359 |
| Friday | 5/0000-2359 |
| Saturday | 6/0000-2359 |
| Weekday | 1/0600 to 5/1759 |
| Weekday Mornings | 1-5/0000-1059 |
| Weekday Afternoons | 1-5/1100-1759 |
| Weekday Evenings | 1-5/1800-2359 |
| Day | 0-6/0700-1759 |
| Night | 0-6/1800-2359, 0-6/0000-0659 |
| Weekday AM | 1-5/0000-1159 |
| Weekday PM | 1-5/1200-2359 |
| Weekend | 0/0000-2359, 6/0000-2359 |

wherein n/x-y is defined as:
n day of a week (0 to 6)
x and y times of the day in 0000 format (e.g. 1800 stands for 18h00)
x-y interval of a time in a day

For each widget, the configuration settings may be expressed according to each parameter defined intervals. In repository 125, the preferences may be organized by widgets and each parameter interval. Thus each configuration setting of a widget may be divided into preference sets, each preference set listing the widget configuration data valid for the parameter interval attached to said preference set. In order to facilitate the retrieval of the right configuration settings, the information may be sorted out in repository 125 mainly by the parameter intervals, i.e. for each preference subset, the configuration data for all the widgets is defined. Other organization of the configuration settings stored in repository 125 are readily available to the man skilled in the art.

An example of configuration settings is illustrated here below, it correspond to the traffic, stock and weather widgets that can be seen in FIG. 6 in an exemplary illustration of a mobile display. Their configuration is to vary depending on the moment of the week, namely on weekdays in the morning (weekday AM), weekdays in the afternoon (weekday PM) and weekends, these intervals corresponding to the definition illustrated in Table 1. Four preference subsets are available, corresponding to these three intervals and one default subset. Each subset comprises the widget name, class (here corresponding to a Javascript class), and path to retrieve the widget itself. The configuration data is also provided for each widget, e.g. for the weather widget, it may be different weather locations to display depending on the time interval, for the traffic, it may be a different itinerary to display, or simply the traffic in the vicinity of the end device actual location, and for the stock widget a list of stocks to monitor. As nine positions are available on the mobile display in FIG. 6, nine entries are provided for the widget names, classes and paths, ″″ corresponding to an empty or unused position. In the example here after, the configuration is set so that the weather, stock and traffic widgets are on display during the weekdays, AM and PM, the display changing to the weather and sports widgets during the weekend (i.e. only two widget icons used).

*(Default)
({“name”:“WidgetName”,“settings”:

(“weatherd”, “stockd”, “trafficd”,
“”, “”, “”,
“”, “”, “”,)},

{“name”:“WidgetClass”,“settings”:

(“weatherWidget”, “stockWidget”, “trafficWidget”,
“”, “”, “”,
“”, “”, “”)},

{“name”:“WidgetPath”,“settings”:

(“../weather”, “../stock”, “../traffic”,
“”, “”, “”,
“”, “”, “”)})

*(Weekday AM)
({“name”:“WidgetName”,“settings”:

(“weatherd”, “stockd”, “trafficd”,
“”, “”, “”,
“”, “”, “”)},

{“name”:“WidgetClass”,“settings”:

(“weatherWidget”, “stockWidget”, “trafficWidget”,
“”, “”, “”,
“”, “”, “”)},

{“name”:“WidgetPath”,“settings”:

(“../weather”, “../stock”, “../traffic”,
“”, “”, “”,
“”, “”, “”)})

*(Weekday PM)
({“name”:“WidgetName”,“settings”:

(“weatherd”, “stockd”, “trafficd”,
“”, “”, “”,
“”, “”, “”)},

{“name”:“WidgetClass”,“settings”:

(“weatherWidget”, “stockWidget”, “trafficWidget”,
“”, “”, “”,
“”, “”, “”)},

{“name”:“WidgetPath”,“settings”:

(“../weather”, “../stock”, “../traffic”,
“”, “”, “”,
“”, “”, “”)},

*(Weekend)
({“name”:“WidgetName”,“settings”:

(“weatherd”, “mlbd”, “”,
“”, “”, “”,
“”, “”, “”)},

{“name”:“WidgetClass”,“settings”:

(“weatherWidget”, “mlbWidget”, “”,
“”, “”, “”,
“”, “”, “”)},

{“name”:“WidgetPath”,“settings”:

(“../weather”, “../mlb”, “”,
“”, “”, “”,
“”, “”, “”)})

Depending on how the information is organized, preference module may browse repository 125 by widget first for all the widgets comprises in the set of widgets, and then by parameter intervals. If the information is organized mainly by the parameter intervals, the need to browse widget after widget is no longer needed.

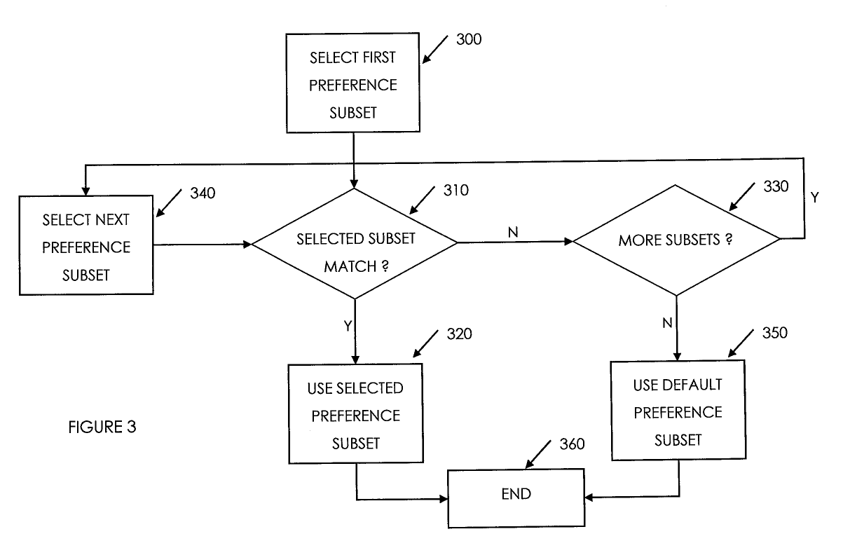

FIG. 3 shows an exemplary illustration of act 220 for the time parameter. The widget configuration settings may be defined in the preference repository for each time range listed here above. In a preliminary act 300, preference module selects a first preference subset corresponding to a first time interval. In a further act 310, preference module checks if the selected preference subset apply to the current time of the end device, i.e. if the current time is comprised in the time interval of the selected subset. If so, the selected preference subset is retained in a further act 320 as the subsequent configuration of the set of widgets. If not, in a further act 330, the preference module verifies if more subsets are available, if so, it selects the next preference subset in the configuration settings in an act 340 and proceeds again with act 310. if no more subset are available as checked in act 330, the preference module proceeds with retaining the default subset in a subsequent act 350. The browsing of the preference subsets ends in a further act 360 subsequent to act 350 or 320.

Depending on how repository 125 is organized, preference module 120 may repeat acts 300 to 360 for each widget. The widget module may even update the widget display on a widget after widget basis. In an alternative embodiment of the present method, preference module performs these acts only once if each preference subset comprises configuration data for the whole set of widgets.

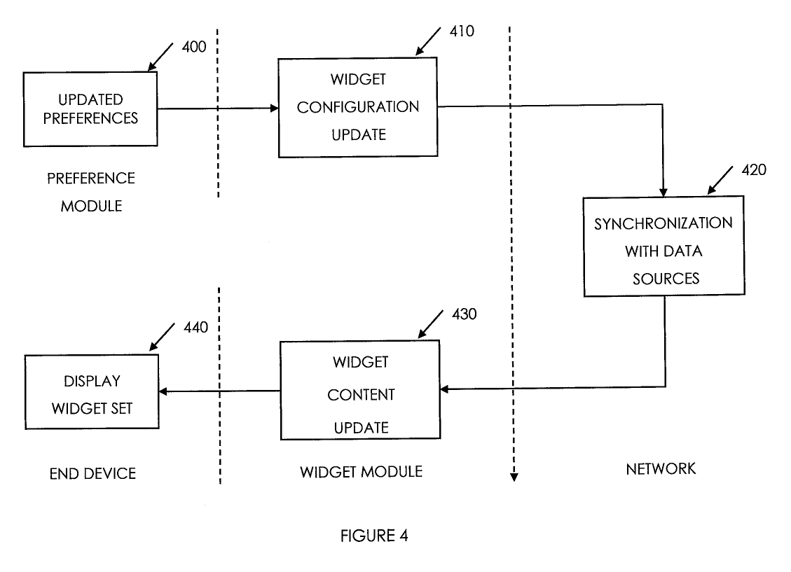

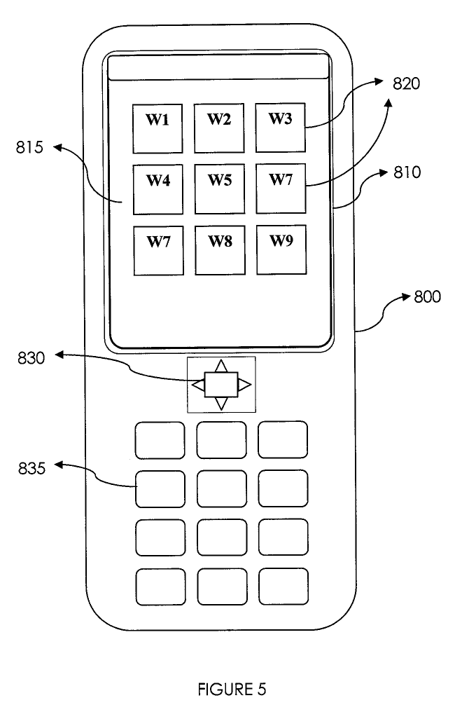

FIG. 4 shows an exemplary illustration of the widgets content shift, once the updated configuration settings have been retrieved by the preference server in a preliminary act 400. In a further act 410, widget module checks among the active widgets the one that will require a content update. In a further act 420, the updated content is synchronized with the relevant data sources, e.g. websites for news widgets. With the updated configurations settings and content, widget module may proceed with building the update widget page in a subsequent act 430, and send this page for a further upload by the end device for display in act 440.

To date mobile web content is typically modified to render web pages onto small screens. For mobile applications a wide range of techniques can be used to adapt the content. Some implementations repurpose content by, for example, eliminating tables and scaling images. These techniques are commonly known as small screen rendering (SSR). Such content adaptation can occur in the network, or locally on the device to minimize bandwidth usage.

Content adaptation in this context requires identifying the characteristics of the device because content displays differently on various devices. A HTTP request header is one mechanism by which device characteristics can be determined. HTTP headers are name/value pairs that appear in both request and response messages. The name of the header is separated from the value by a single colon, for example: User-Agent: Mozilla/4.0 (compatible; MSIE 6.0; Windows NT 5.1) Provides a header: User-Agent whose value is Mozilla/4.0 (compatible; MSIE 6.0; Windows NT 5.1). The purpose of this particular header is to supply the web server with information about the type of browser making the request. A complete definition of this and other commonly encountered HTTP headers can be found in the World Wide Web consortium (W3C) HTTP 1.1 specification. Such techniques are widely used to adapt content.

The present system and method extend the content adaptation by introducing a new method for adapting content on a device.

The state shift obviates the need to scroll though lists of widgets because the time based preferences (or other parameter based preferences) allow pre-selection of widgets to take place. Even a small number of mobile widgets can take up most of the available screen real-estate resulting in a poor user experience that makes it hard to identify the desired widget. State shift automatically determines what widget to display from a plurality of widgets based on a defined set of rules identifying whether to display widgets to the user.

The present system allows the control of when and for how long a widget is displayed as well as the control of what content should be presented. For example, a traffic widget for a journey home can be displayed ten minutes before leaving the office, while during the day it can be suppressed allowing other widgets to be displayed. This example is further illustrated in FIG. 6.

Furthermore, the content shift provides a unique mechanism for the display of a single widget. Through the content shift, widgets are able to use contextual information, including but not limited to current time and location of the display device, to tailor displayed content. This capability results in the presentation of information that is relevant to the user at all times. Context aware content display can be accomplished through the use of context-based widget preferences. For example, a news feed generated from a RSS widget could display current world news in the morning, stock market reports at noon and finally a sport feed at the end of the day. With existing widget technology this can only be achieved by manually setting the preferences for each individual widget to reset the RSS channel.

The present system allows context aware widget display without modifying the core code of the widget. Instead, the widget module controls when and how to display widgets by evaluating end device context against a set of defined rules on a preference module and returning to the widget display device a context-selected set of response data. This returned data may include the widgets themselves, as well as the underlying information the widgets use for generating the display presented to the end-user. As seen before, for the widgets which are already activated in the GUI, the returned data may only include the updated preferences. In some respects the present system is an additional layer of widget management control.

When the monitored contextual information comprises the device time, various granularity may be defined. As time elapses through the week and day, new applications will appear, some will change their appearance, while others are suppressed from view. The automated control of a mobile device graphical user interface can dramatically improve the experience on small devices by presenting only those widgets though a user preference configuration.

Of course, it is to be appreciated that any one of the above embodiments or methods may be combined with one or more other embodiments and/or methods or be separated and/or performed amongst separate devices or device portions in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow.

The focus of the illustrations has been on the development of a web-based widget module, using mini-applications that run as a browser. To this end, many of the implementation of these illustrations may leverage well defined Web standards of XHTML1.1, CSS2.1, DOM and JavaScript.

A web standards-based widget approach can be contrasted to applications that run on devices that are compiled for a specific target architectures, for example a windows DLL (dynamically linked library) or a Java application. Other embodiments may be available within the scope of the present system. All modules, and their related functions may be stored in a single end device, like a mobile phone or a computer. The selection of the widgets of interest to a user, as well as the type of editor he/she may use to configure the context based preferences is beyond the scope of the present system.

While the source code, or markup that defines a widget, is an area of some debate within the industry, it is not essential to the novelty of the present system. It is possible to manage widgets using the method and techniques described in the present system and method.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A method for managing a set of widgets displayed on the graphical user interface (GUI) of a device, said method comprising the acts of:
receiving contextual data from the device,
querying with the received contextual data a repository of widget configurations for the set of widgets, said widgets configurations being described in said repository as functions of the possible contextual data values,
displaying the set of widgets using the configuration that match the received contextual data.

2. A method according to claim 1, wherein the contextual data comprises the device time.

3. A method according to claim 1, wherein the contextual data comprises the device location.

4. A method according to claim 1, wherein the widget configurations comprise an active/inactive state as a function of the possible contextual data values.

5. A method according to claim 1, wherein the possible contextual data values are divided into intervals of possible values.

6. A method according to the previous claim 5, wherein the widget configurations is stored in the repository as functions of the intervals of possible values.

7. A processor configured to manage a set of widgets displayed on the graphical user interface (GUI) of a device, said processor comprising:
a portion configured to receive contextual data from the device,
a portion for querying with the received contextual data a repository of widget configurations for the set of widgets, said widgets configurations being described in said repository as functions of the possible contextual data values,
a portion configured to display the set of widgets using the configuration that match the received contextual data.

8. A processor according to claim 7, wherein the contextual data comprises the device time.

9. A processor according to claim 7, wherein the contextual data comprises the device location.

10. A processor according to claim 7, wherein the widget configurations comprise an active/inactive state as a function of the possible contextual data values.

11. A processor according to claim 7, wherein the possible contextual data values are divided into intervals of possible values.

12. A processor according to the previous claim 11, wherein the widget configurations is stored in the repository as functions of the intervals of possible values

13. A computer readable carrier including computer program instructions that cause a computer to implement a method for managing a set of widgets displayed on the graphical user interface (GUI) according to claim 1.

14. A graphical user interface coupled to the processor of claim 7 to display a set of widgets.

15. A telecommunication device arranged to manage a set of widgets displayed on the graphical user interface (GUI) of said device, the telecommunication device being further arranged to:
acquire contextual data for the telecommunication device,
query with the acquired contextual data a repository of widget configurations for the set of widgets, said widgets configurations being described in said repository as functions of the possible contextual data values,
display the set of widgets on the GUI using the configuration that matches the received contextual data.
